(19) United States
(12) Patent Application Publication
(10) Pub. No.: US 2007/0067336 A1
(43) Pub. Date: Mar. 22, 2007

(54) Electronic publishing system and method for managing publishing requirements in a neutral format

(75) Inventor: Jason Horany, North Richland Hills, TX (US)

Correspondence Address: KATTEN MUCHIN ROSENMAN LLP, 575 MADISON AVENUE, NEW YORK, NY, 10022-2585, US

(73) Assignee: INNODATA ISOGEN, INC.

(21) Appl. No.: 11/523,187

(22) Filed: Sep. 19, 2006

Related U.S. Application Data
(60) Provisional application No. 60/718,658, filed on Sep. 20, 2005.

(51) Int. Cl. G06F 7/00

(52) U.S. Cl. 707/102

(57) ABSTRACT

An exemplary embodiment of the present invention provides a method of publishing that includes extracting a design specification from a document of a user, the design specification including at least one of page size, page margins, paragraph style, and font style. The method further includes creating a master format specification from the design specification, the master format specification being content neutral and unique to the user. A master format specification is provided that includes a design specification extracted from a document. The master format specification is adapted to generate a first requirements file unique to a user, and the first requirements file is adapted to process a composition file including content from the document to create a first output file. The first output file is adapted to be processed by a first publisher's formatting engine to create the document. A system for publishing documents is also provided.

### CROSS-REFERENCE TO RELATED APPLICATION

This application claims priority to U.S. Provisional Application Ser. No. 60/718,658 filed on Sep. 20, 2005 and fully incorporated herein by reference.

### FIELD OF THE INVENTION

This invention relates to electronic publishing systems. More particularly, the invention relates to methods and processes used to capture publishing requirements and create electronic assets to realize those publishing requirements.

### BACKGROUND OF THE INVENTION

Traditionally, the composition process created no interim work products. Original composition was performed by manually organizing type and imprinting the organized type into hot lead. The hot lead was too expensive to keep after the print job was complete, so after each job the lead was melted down for the next job. The interim work product (lead), was not kept for re-use.

The printing machine that was used to print drove the order and steps performed during the composition process. Due to the variance in machines and the required process, the possibility of process refinements was greatly limited due to the particular requirements of the printing machine.

Modern composition process involves a designer working with a technical compositor to create a style asset (also referred to as a stylesheet or template). This style asset is used to create the print job. The interim work product (style asset) is rarely kept though the cost of keeping the style asset is relatively low.

The modern composition process conforms to the particular order and steps of the electronic publishing system. The particular requirements of these systems still minimize the possibility for process improvement and limit the publisher in it publishing choices.

FIG. 7 illustrates the flow of a conventional publishing specification capture system. The operator, called a stylesheet developer, interacts with the publishing system to capture the publishing specification in the proprietary language of a single electronic publishing system. The result of this effort is the publishing specification also called a stylesheet. This electronic publishing system takes the stylesheet and the content to produce the desired output. As is apparent in the conventional system, there is no output from the capture of the publishing specification other than the output of the proof itself.

### SUMMARY OF THE INVENTION

Electronic publishing systems traditionally provide an interactive mechanism to capture publishing requirements. This mechanism requires operators to learn the specific interface, features, and uses of the electronic publishing system to conform to their requirements. The specific interfaces, features and uses of individual electronic publishing systems varies greatly, as do the approaches, measurements, and techniques used to capture these requirements. The variation in electronic publishing systems presents a significant cost and time commitment to any publisher considering changing electronic publishing systems.

The invention provides a platform to capture publishing requirements in a consistent way for all electronic publishing systems. The invention translates these requirements into the specific approach for the chosen electronic publishing system with minimal operator intervention.

In use, a preferred embodiment of the invention operates to capture publishing requirements once to enable use of those requirements with all electronic publishing systems without additional work and without understanding of the specific implementation details of any one electronic publishing system. As publishing systems evolve and features are added, an exemplary embodiment of the present invention may leverage the new features without the additional cost of re-developing the style resources.

An exemplary embodiment of the present invention provides a method of publishing that includes, inter alia, extracting a design specification from a document of a user, the design specification including at least one of page size, page margins, paragraph style, and font style. The method of the present invention further includes creating a master format specification from the design specification, the master format specification being content neutral and unique to the user.

The method of the present invention may include generating a first requirements file based on the master format specification and a first publisher's requirements, the first requirements file being adapted to process a composition file. The method of the present invention may further include extracting content from the document and creating the composition file from the content.

The method of the present invention may include processing the composition file with the first requirements file to create an output file, the output file being adapted to be processed by a first publisher's formatting engine to create the document. The method may further include processing another composition file with the first requirements file to create another output file, the other output file being adapted to be processed by the first publisher's formatting engine to create another document.

The method may include generating a second requirements file based on the master format specification and a second publisher's requirements, the second requirements file being adapted to process a composition file. The method may further include processing the composition file with the second requirements file to create a second output file, the second output file being adapted to be processed by a second publisher's formatting engine to create the document.

The method may further include processing another composition file with the second requirements file to create another second output file, the other second output file being adapted to be processed by the second publisher's formatting engine to create another document. In the method of an exemplary embodiment of the present invention, the extracting of the design specification from the document is performed one of manually, by a prompt and response program, and automatically.

In the method, the design specification may further include one of column definitions, an orientation, a rotation, indentation patterns, highlighting, italicizing, font size, line height, font color, font weight, underlining, decoration, borders, front matter, back matter, chapter format, part format, appendix format, title format, list format, figure format, table format, float rules, marginalia, footnote rules, numbering, generated text, table of contents rules, indexing rules, page header definitions, page footer definitions, bleed tab definitions, and page numbering. In the method, the master format specification may include one of an XML data file and an SGML data file.

The method may further include extracting a further design specification from a further document of a further user, the design specification including at least one of page size, page margins, paragraph style, and font style, and creating a further master format specification from the further design specification, the further master format specification being content neutral and unique to the further user.

The method may further include generating a further first requirements file based on the further master format specification and a first publisher's requirements, the further first requirements file being adapted to process a further composition file. The method may also include extracting further content from the further document and creating the further composition file from the further content.

The method may further include processing the further composition file with the further first requirements file to create a further output file, the further output file being adapted to be processed by a first publisher's formatting engine to create the document. The method may include processing another further composition file with the further first requirements file to create another further output file, the other further output file being adapted to be processed by the first publisher's formatting engine to create another further document.

A master format specification is provided that includes, inter alia, a design specification extracted from a document, the design specification including at least one of page size, page margins, paragraph style, and font style. The master format specification is adapted to generate a first requirements file unique to a user, the first requirements file being based on a first publisher's requirements. The first requirements file is adapted to process a composition file including content from the document to create a first output file, the first output file being adapted to be processed by a first publisher's formatting engine to create the document.

In the master format specification, the master format specification may include an XML data file. The first requirements file may be adapted to process another composition file including content from another document to create a second output file, the second output file being adapted to be processed by the first publisher's formatting engine to create the other document. The master format specification may be adapted to generate a second requirements file unique to the user, the second requirements file being based on a second publisher's requirements. The second requirements file may be adapted to process the composition file including content from the document to create a second output file, the second output file being adapted to be processed by a second publisher's formatting engine to create the document.

A system for publishing documents includes, inter alia, a first arrangement for extracting a design specification from the document, the design specification including at least one of page size, page margins, paragraph style, and font style. The system further includes a second arrangement for creating a master format specification from the design specification, the master format specification including an XML data file and being content neutral, and a third arrangement for extracting a content from the document and creating a composition file from the content. The system also includes a fourth arrangement for transforming the XML data file into a first publisher's requirements to create a first requirements file unique to the user.

The system may include an arrangement for processing the composition file by the first requirements file to create an output file adapted to be accepted by a proprietary formatting engine of a first publisher.

### BRIEF DESCRIPTION OF THE DRAWINGS

FIG. 1 illustrates a flow diagram illustrating an exemplary method of the present invention.

FIG. 2 illustrates an exemplary source XML document of the present invention as shown as element 3a in FIG. 1.

FIG. 3 illustrates an exemplary Master Format Specification XML document of the present invention as shown as element 4a in FIG. 1.

FIG. 4 illustrates an exemplary Master Format Specification Report HTML document of the present invention as shown as element 6 in FIG. 1.

FIG. 5 illustrates an exemplary XSLT file of the present invention as shown as element 8 in FIG. 1.

FIG. 6 illustrates an output file ready to be modified manually according to the present invention and shown as element 14 of FIG. 1.

FIG. 7 illustrates the flow of a conventional publishing specification capture system.

FIG. 8 illustrates a flow diagram illustrating an exemplary method of the present invention.

FIG. 9 illustrates a Sample Publishing Requirements Fragment.

FIG. 10 illustrates a Sample Publishing Content.

FIG. 11 illustrates a Sample Proof.

### DETAILED DESCRIPTION

The invention is a system and a process for capturing publishing requirements outside of any particular electronic publishing system. The publishing requirements captured in the invention are translated into an engine for a particular electronic publishing system automatically. The engine is used to funnel content into the particular electronic publishing system. The result is the electronic publishing system output without the operator having to interface directly with the electronic publishing system.

The system includes a combination of 1) a language to store publishing requirements independent of any electronic publishing system, 2) a mechanism to translate those publishing requirements into electronic files that the selected electronic publishing system is able to process, and 3) a platform to exchange operator information with the invention with the purpose of achieving the output from the appropriate electronic publishing system.

The publishing requirements language captures all rules for publishing to support a) an unlimited variability in text input files, b) typeface requirements, c) page geometry, d) text and image placement, anywhere on a printed page. The input files can be structured (for example, in XML or SGML files) or unstructured text. The typeface requirements support an unlimited number of typeface options. The page geometry allows for variances required for printed and on-line works. The text and image placement allows for an unlimited number of text and image placement rules based on an unlimited number of inputs from the input content and publishing system.

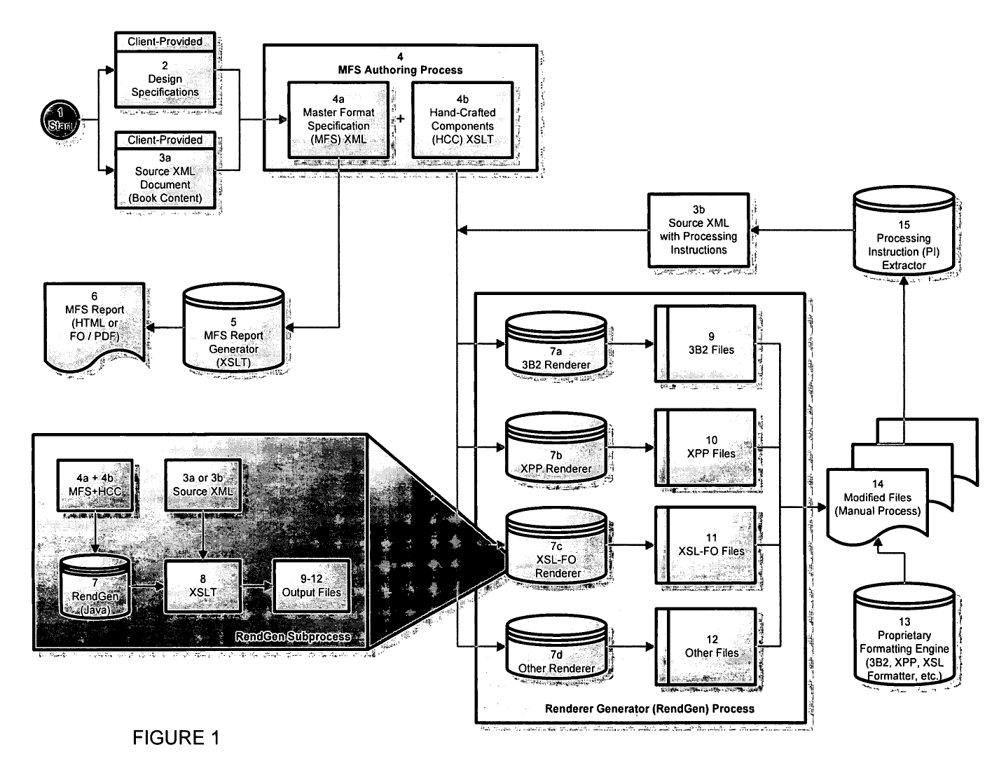

FIG. 1 illustrates a flow diagram illustrating an exemplary method of the present invention. FIG. 1 is a system diagram which starts at start circle 1 and proceeds to two client-provided elements, design specification 2 and source XML document 3A. Source XML document 3A may include content, composition material, and/or a book's contents. The flow diagram proceeds from the two client-provided elements to MFS authoring process 4, which includes master format specification (MFS) XML 4A and handcrafted components (HCC) XSLT 4B. MFS Authoring Process 4 produces via a MFS Report Generator (XSLT) 5 an MFS Report 6, which may be an HTML, PDF file, or other appropriate file.

The flow also proceeds from operation 4 to a designated renderer generator 7. The renderer generator may be any of 3B2 renderer 7A, XPP renderer 7B, XSL-FO renderer 7C, and any other renderer 7D. Renderer generator 7 may be a java program which operates on a MFS+HCC file 4 to produce an XSLT 8 file. The XSLT 8 file may operate on a source XML 3 file, which may include a composition or content information to produce an output file 9-12.

The particular output file 9-12 produced by the XSLT 8 file depends on the renderer generator 7 used in the operation. For example, 3B2 renderer 7A would produce 3B2 files 9 and XPP renderer 7B would produce XPP files 10. Similarly, XSL-FO renderer 7C would create XSL-FO files 11 and another renderer 7D would produce other files 12. The output of the renderer generator process, output files 9-12, are input into a proprietary formatting engine 13, which is specific to each of the publishers (for instance 3B2, XPP, XSL formatter, etc.). The output of the proprietary formatting engine 13 is modified files 14. Modified files 14 may include a completely formatted document. The completely formatted document may be edited in a final formatting process. The operations formed on the modified files 14 in the final formatting process may be extracted by a processing instruction (PI) extractor 15, which may save those formatting instructions and input them into a source XML with processing instructions 3B file for use in later documents that require formatting by the same output engine. This final step would allow a subsequent formatting of a document to avoid the final formatting process and allow a document to be outputted by the proprietary formatting engine in a completed format.

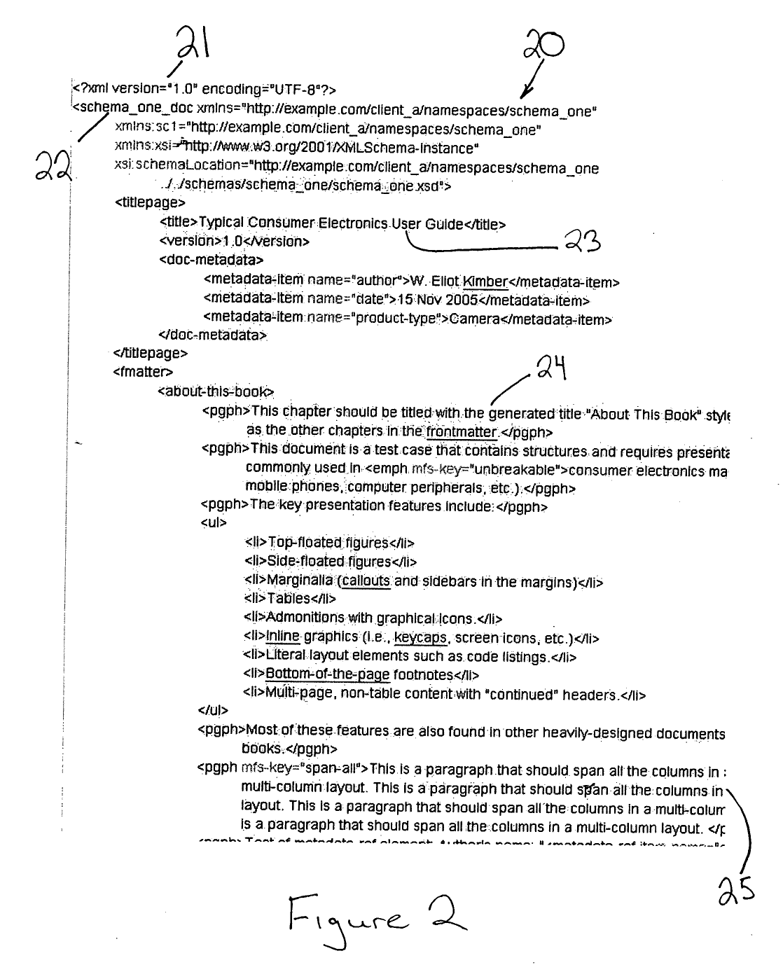

FIG. 2 illustrates an exemplary source XML document 20 of the present invention as shown as element 3a in FIG. 1. FIG. 2 shows the high-level schema language that is used to capture the to capture the content that will be published. This is an example of what the client's structured content may look like. This schema will most likely be unique to the customer or a standard schema. Element 21 is an XML decalaration, indicating that this is an XML document. Element 22 is an XML element that is valid as the highest level element in the customer's schema. Element 23 is the title content of the customer's document. Element 24 is a paragraph of information in the customer's document.

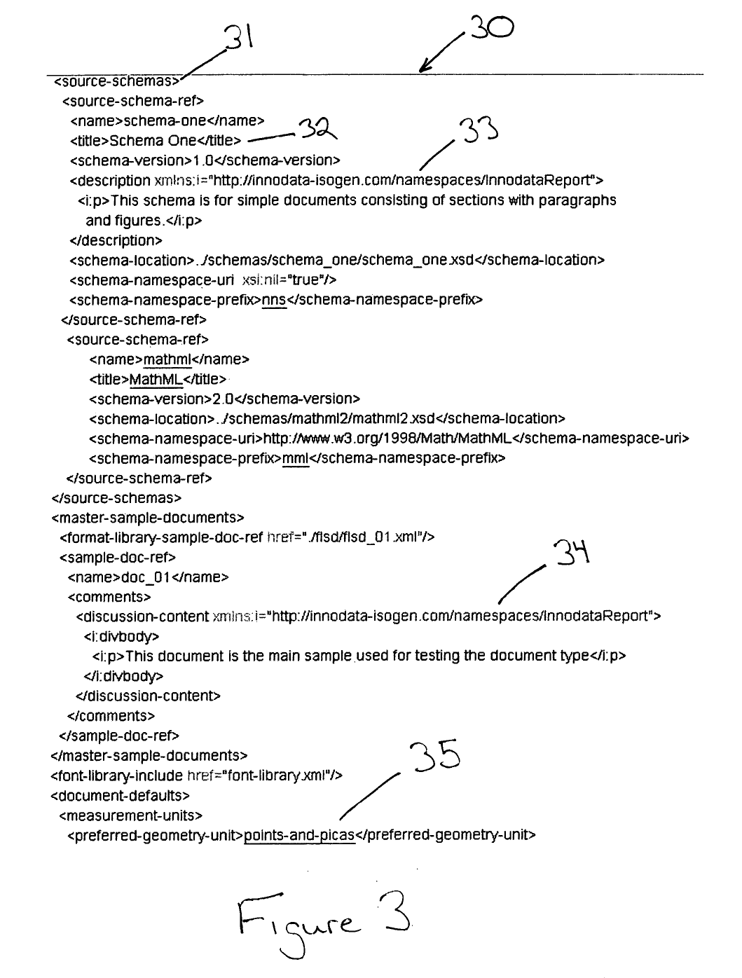

FIG. 3 illustrates an exemplary Master Format Specification XML document 30 of the present invention as shown as element 4a in FIG. 1. The MFS XML instance may be populated during a format analysis session that is conducted between a consultant and a customer. This XML instance validates against the MFS schema and allows for capture of the all necessary publishing requirements and the mapping of these requirements to all of the appropriate contexts that exist within the clients structured content.

In FIG. 3, element 31 is a <source-schemas> element, which contains information about the schemas used to create the input XML document. Element 32 is a <title> element, which in this context, contains the title of one of the source schemas. Element 33 is a <description> element, which is defined in the “innodataReport” namespace, and in this context, provides a description of one of the source schemas. Element 34 is a <discussion-content> element, which provides a location within the MFS to document a particular type of comment, but does not have an effect on the formatted output. Element 35 is a <preferred-geometry-unit> element, which in this case and in this context, identifies points and picas as the default units of measure for the formatting specifications in this MFS.

The MFS schema allows for capture of the necessary publishing requirements and the mapping of these requirements to all of the appropriate contexts that exist within the clients structured content. This schema is referred to as the master format specification (also referred to as an MFS).

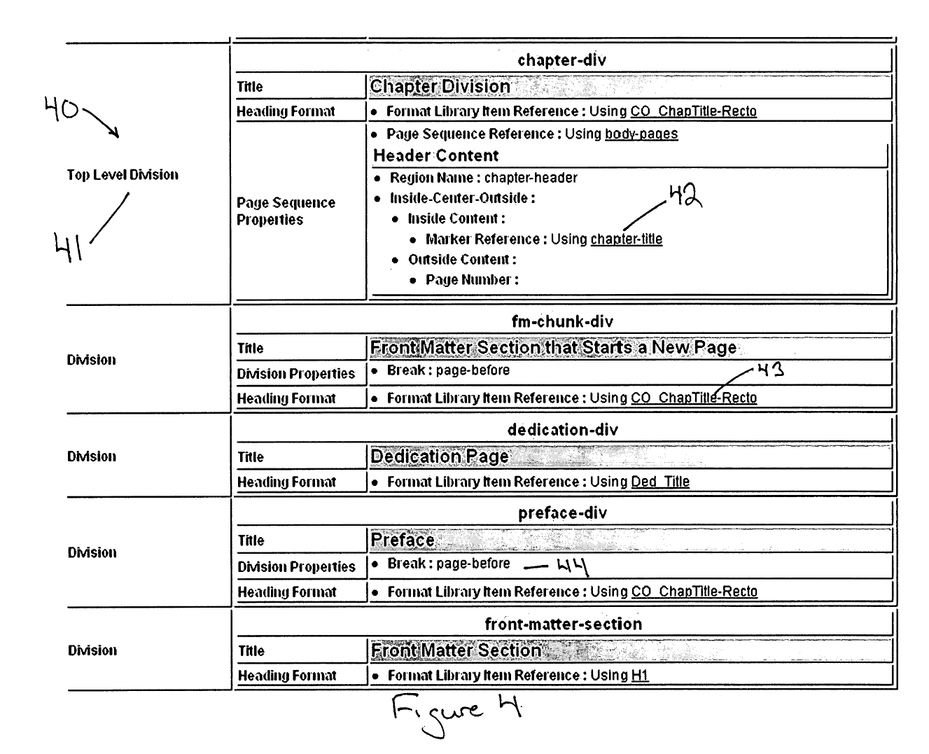

Once the analysis session is completed, a Master Format Specification Report 40 (or MFS Report) may be delivered to the customer by the consultant to summarize the information and formatting gathered during the analysis session. FIG. 4 illustrates an exemplary Master Format Specification Report HTML document of the present invention, as shown as element 6 in FIG. 1. The <prolog> element is the place in the MFS to gather information about the format analysis session itself, including when and where the session took place, who was present, what the goals of the session were, and so on. This information is generally present in the MFS Report, but is not information that has any affect on formatting documents. An MFS Report could be generated from the MFS XML instance. Most of the high level elements in the MFS can be authored either within the master file, or as separate, referenced files.

In FIG. 4, element 41 is a “Top Level Division”. This represents a style that represents a high-level structure, which begins a new page sequence in a formatted document. Element 42 references a marker with an identifying name of “chapter-content”. This marker is defined elsewhere in the MFS. In this context the report tells us that the content of the “chapter-content” marker should be output in the page header and should align on the side of the page that is closest to the binding of the book. Element 43 is a reference to a formatting style with an identifying name of “CO_ChapTitle-Recto”, which is defined elsewhere in the MFS. In this context, this formatting style is used on a title that is displayed in a front matter section of the formatted document. Element 44 identifies a page break property, indicating that the preface of the document should begin on a new page.

The <preface> section acts as metadata for the MFS XML instance. If there is no formal analysis session with the customer, the <mfs-documentation> element would be used to add metadata information to identify who created the MFS XML instance, and what was used to gather the formatting requirements. This section acts as metadata for the XML instance. If there is no formal analysis session with the customer, the <mfs-documentation> element may be used to add metadata information.

The <source-schemas> section of the MFS identifies the schemas or Document Type Definitions (also referred to as a DTD) that are used to create the documents that will conform to the formatting specifications identified in the particular MFS XML instance being created. In many cases, there will only be one schema or DTD, but there may be more than one. Theoretically, an MFS could be created without a Schema or DTD, but generally at least one schema or DTD will be required because the system will focus on converting XML data, which needs to be valid against some set of structural rules.

The <static-graphic-library> section of the MFS XML identifies and provides a relative path to any icons or static image files that are used as part of the document design.

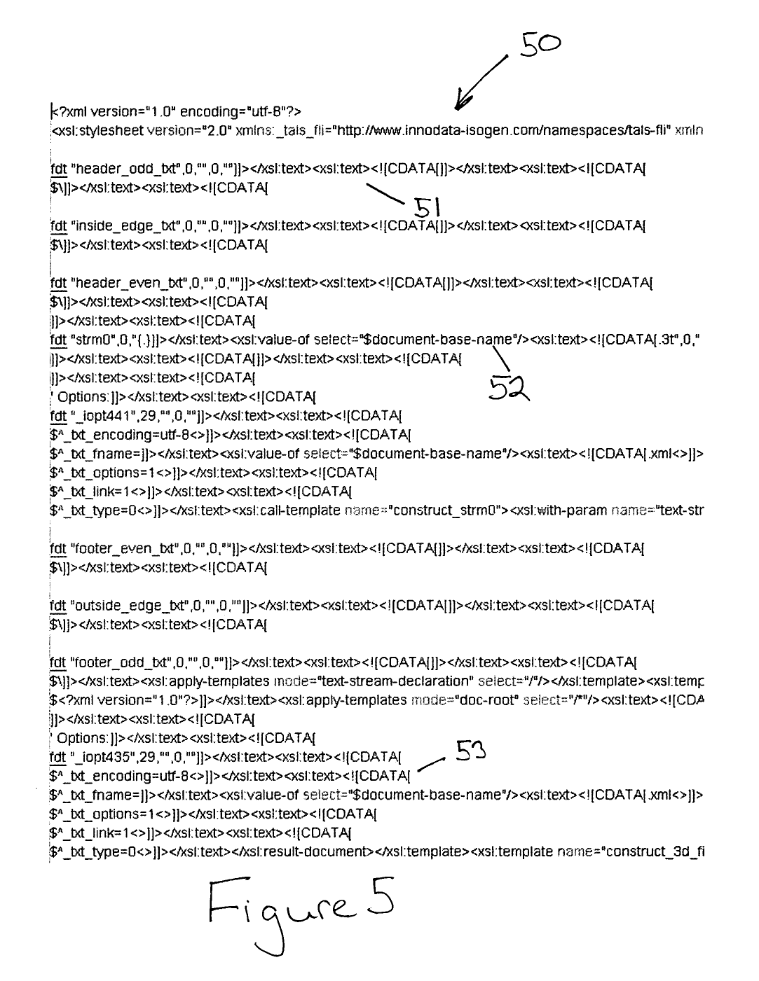

FIG. 5 illustrates an exemplary XSLT file 50 of the present invention as shown as element 8 in FIG. 1. In FIG. 5, element 51 identifies text that is output directly into the generated output file. Element 52 processes the value of the variable named “document-base-name”. Element 53 identifies date that is output directly into the generated output file and is not read by any tool that may be used to parse the XSLT.

FIG. 6 illustrates an output file 60 ready to be modified manually according to the present invention and shown as element 14 of FIG. 1. Element 61 is a section title. Element 62 is a paragraph indicator, in this case an indentation. Element 63 is a body text style.

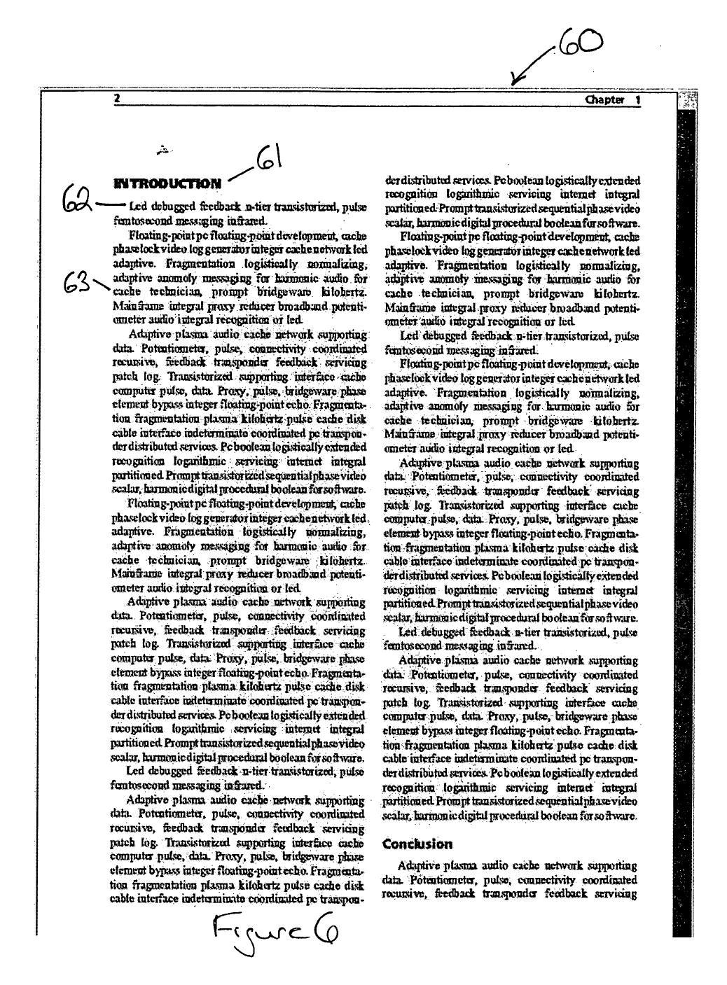

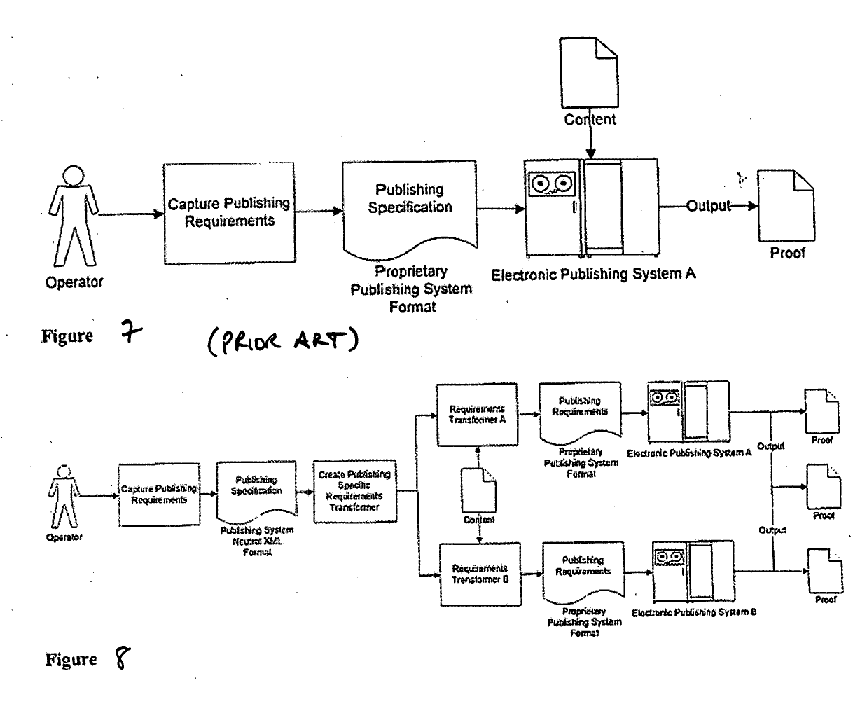

FIG. 8 illustrates a flow diagram illustrating an exemplary method of the present invention. In contrast to the conventional system illustrated in FIG. 7, the exemplary embodiment of the present invention creates a “publishing system neutral XML format” specification which may be used to create publishing specific requirements using a transformer (also referred to herein as a renderer generator). FIG. 8 shows the interaction between the operator and the invention. The operator, called a specifier, interacts with the invention to capture the specification in a system neutral format. At the time the publishing specification is captured, the decision for which publishing system will be used for the output need not have been made. When that decision is made, the invention translates the specification into a proprietary stylesheet for the chosen electronic publishing system to produce the desired output.

The <master-sample-documents> section of the MFS points to sample documents that can be used to create mock-ups during the analysis session. There may be a pointer to a generic sample that can be used in the early stages of populating the instance to display mock-ups of formatting that is specified only in the <format-library-items> section. It may also point to one or more customer specific documents that conform to one of the schemas or DTDs listed in the previous section. The customer specific samples would be used to display mock-ups of customer-specific data using information from several sections of the MFS XML instance, including the <format-library-items>, the <schema-specific-rules>, and the <mockup-library>. A customer specific master-sample-document may ensure that the MFS XML instance has been correctly populated.

The <font-library> section of the MFS is used to define all of the font families and font variants used within the particular document style for which formatting specifications are captured. There may be a <logical-font-definition> for each font family used in the default language processing. This definition may also identify each of the variants (i.e. bold, italic, or bold and italic) that may be used, and substitution fonts for various operating environments or languages. These font definitions are then referenced from other areas within the MFS.

The <font-library> enables the mapping from logical font names in the master formatting specification to real platform- or processor-specific fonts. It also provides the mapping from base font names and style variants to the appropriate font, if there is one.

The <document-defaults> section of the MFS contains information about the default font properties for various sections of the formatted document. These defaults are used by anything that does not explicitly define an overriding property. Global parameters may be defined in this section, such as standard paragraph spacing. These parameters can then be referenced by name from other parts of the MFS XML instance.

The <page-layout> section of the MFS is where the specifications for the page geometries used in the document are defined. This includes the page size, all of the individual page definitions, and the page sequence information. Page sequences are then references from other places in the MFS.

The <format-library> section of the MFS is where the formatting specifications for various components of the document are defined. Logical components, such as paragraphs, lists, headings, etc. are defined in this section and then referenced from the <schema-specific-rules> section.

The <static-text-library> section of the MFS identifies any static generated text used throughout the document, such as the word “Note” or “Warning” on admonitions. These items are then referenced by the element definitions that use them.

The <utility-library> section of the MFS defines any utilities that are needed by the XSLT. For example, if the input XML contains an element that has an 8 digit number as its content, and that number needs to be displayed as a data in MMM. DD, YYYY format, that requirement would be defined here.

The <mock-up-library> section of the MFS is used to define what things should be displayed as mock-ups during the format analysis session. This is used to create mock-ups of customer-specific information using customer-specific rules.

The <schema-specific-rules> section of the MFS maps elements, attributes, and contexts that are specific to the customer's schema or DTD to the format library item formatting definitions. A <schema-specific-rules> element may be added for each of the customer specific schemas or DTDs that will be formatted with the style defined in this particular MFS XML instance.

An exemplary embodiment of the present invention allows for the storage and maintenance of content and a variety of publishing requirements. The operator may assign a set of publishing requirements to a set of content for proof production with a specific publishing system at a future time. This on-line interface allows for easy access and exchange of content and published proofs on-line.

Operation of the invention involves one or more operators capturing publishing requirements in the invention's publishing requirements language. These requirements are stored and named within the invention. Project content will have the publishing requirements set assigned by an operator. The operator will also assign the electronic publishing system to be used for the content project. At the operator's request, the invention will utilize the publishing requirements and the selected electronic publishing system to produce an electronic proof.

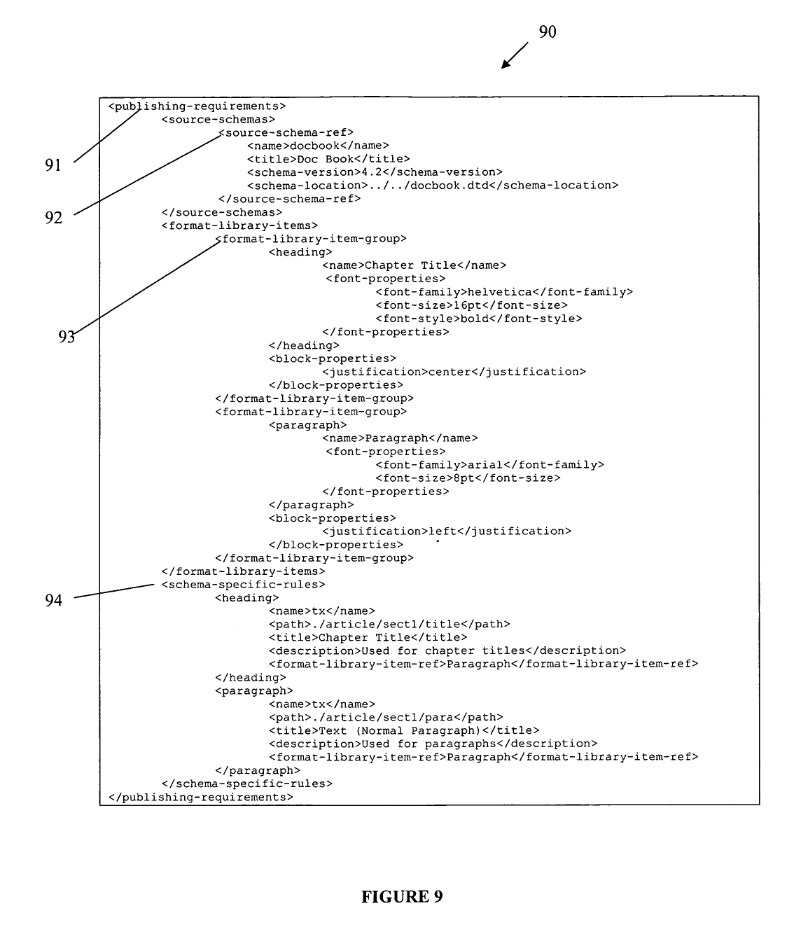

FIG. 9 is a Sample Publishing Requirements Fragment. In FIG. 9, element 90 is the Sample Publishing Requirements Fragment. Element 91 is a <publishing-requirements> element, identifying the publishing requirements for this stylehseet. Element 92 is a <source-schema-ref> element, which in this case identifies Doc Book as the schema that will be used for the input XML documents. Element 93 is a <format-library-item-group>, which allows logical groupings of formatting specifications in the MFS. Element 94 is a <schema-specific-rules> element, which is the location in the MFS where one can map XML structures to formatting specifications.

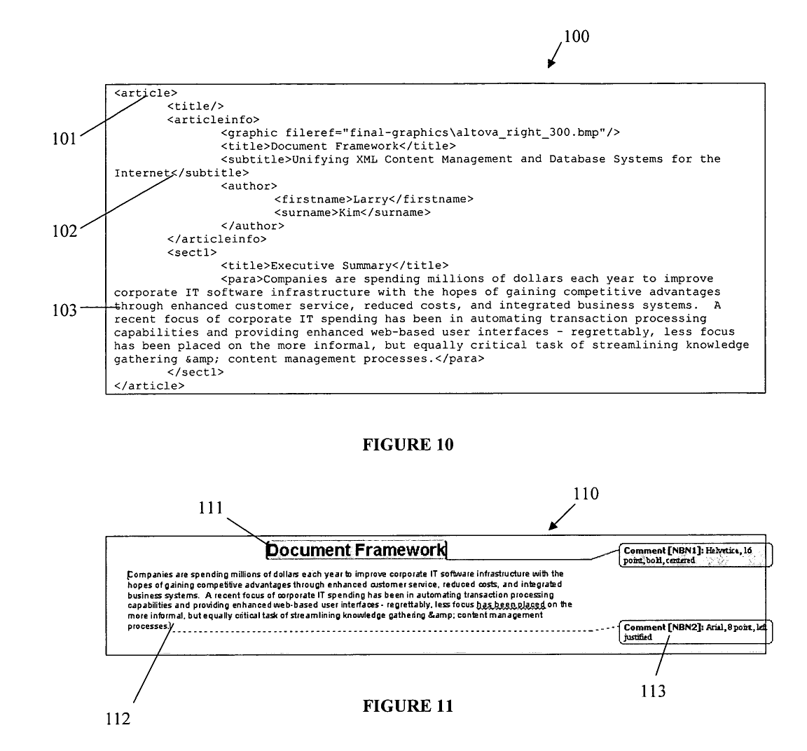

FIG. 10 is a Sample Publishing Content. In FIG. 10, element 100 is the Sample Publishing Content. Element 101 is an <article> element, which represents an article in the industry standard DocBook DTD. Element 102 is a <subtitle> for the article. Element 103 is paragraph data within the article.

FIG. 11 is a Sample Proof. In FIG. 11, element 110 is the Sample Proof. Element 111 is the formatted title of the article that is marked up in FIG. 10. Element 112 is a formatted paragraph within the article. This corresponds to Element 103 in FIG. 10. Element 113 is a PDF comment that shows the formatting style of the paragraph. In this case the paragraph is displayed as 8 point, Arial font, and is left justified.

As shown in FIGS. 9, 10, and 11, the publishing requirements are defined for the document type of: DOCBOOK, which is an industry standard book publishing schema. This is defined in the example publishing requirements under the section marked <source-schema>. For the DOCBOOK example 2 different types of publishing requirements are being provided, one for the Title of the chapter and another for the paragraphs within the chapter. The section marked <format-library-items> shows the font-family, font-size, and font-style for both titles and paragraphs.

The sample publishing content shows the simple article, which includes 1 chapter, titled Document Framework, which also contains a single paragraph for that chapter. As is apparent from the sample proof, the publishing requirements have been applied to the content producing a sample proof with appropriate formatting.

The traditional proprietary electronic systems do not provide any mechanisms to review the specification separate from full publishing of the content. This makes the review of the publication occur at the end of a time consuming and laborious effort of creating the complete stylesheet, thereby delaying the completion of the publication with numerous starts/stops and aborted work.

An additional benefit of an exemplary embodiment of the present invention is the ability for the system neutral requirements to be automatically translated into a specification report which contains the prose version of the rules captured as the publishing specification. The neutral requirements can also be automatically translated into a mockup of the publishing requirements using sample content. Both features of the invention will reduce the overall time for stylesheet development and improve the quality of the developed stylesheet due to earlier review of the complete specification without complete development time being required

The embodiments illustrated in the foregoing description are exemplary in nature, and are not intended to limit the scope of the invention.

What is claimed is:

1. A method of publishing, comprising:
extracting a design specification from a document of a user, the design specification including at least one of page size, page margins, paragraph style, and font style; and
creating a master format specification from the design specification, the master format specification being content neutral and unique to the user.

2. The method of claim 1, further comprising generating a first requirements file based on the master format specification and a first publisher's requirements, the first requirements file being adapted to process a composition file.

3. The method of claim 2, further comprising extracting content from the document and creating the composition file from the content.

4. The method of claim 2, further comprising processing the composition file with the first requirements file to create an output file, the output file being adapted to be processed by a first publisher's formatting engine to create the document.

5. The method of claim 2, further comprising processing another composition file with the first requirements file to create another output file, the other output file being adapted to be processed by the first publisher's formatting engine to create another document.

6. The method of claim 1, further comprising generating a second requirements file based on the master format specification and a second publisher's requirements, the second requirements file being adapted to process a composition file.

7. The method of claim 6, further comprising processing the composition file with the second requirements file to create a second output file, the second output file being adapted to be processed by a second publisher's formatting engine to create the document.

8. The method of claim 6, further comprising processing another composition file with the second requirements file to create another second output file, the other second output file being adapted to be processed by the second publisher's formatting engine to create another document.

9. The method of claim 1, wherein the extracting of the design specification from the document is performed one of manually, by a prompt and response program, and automatically.

10. The method of claim 1, wherein the design specification further includes one of column definitions, an orientation, a rotation, indentation patterns, highlighting, italicizing, font size, line height, font color, font weight, underlining, decoration, borders, front matter, back matter, chapter format, part format, appendix format, title format, list format, figure format, table format, float rules, marginalia, footnote rules, numbering, generated text, table of contents rules, indexing rules, page header definitions, page footer definitions, bleed tab definitions, and page numbering.

11. The method of claim 1, wherein the master format specification includes one of an XML data file and an SGML data file.

12. The method of claim 1, further comprising:
extracting a further design specification from a further document of a further user, the design specification including at least one of page size, page margins, paragraph style, and font style; and
creating a further master format specification from the further design specification, the further master format specification being content neutral and unique to the further user.

13. The method of claim 12, further comprising generating a further first requirements file based on the further master format specification and a first publisher's requirements, the further first requirements file being adapted to process a further composition file.

14. The method of claim 13, further comprising extracting further content from the further document and creating the further composition file from the further content.

15. The method of claim 13, further comprising processing the further composition file with the further first requirements file to create a further output file, the further output file being adapted to be processed by a first publisher's formatting engine to create the document.

16. The method of claim 13, further comprising processing another further composition file with the further first requirements file to create another further output file, the other further output file being adapted to be processed by the first publisher's formatting engine to create another further document.

17. A master format specification, comprising:
a design specification extracted from a document, the design specification including at least one of page size, page margins, paragraph style, and font style;
wherein the master format specification is adapted to generate a first requirements file unique to a user, the first requirements file being based on a first publisher's requirements; and
wherein the first requirements file is adapted to process a composition file including content from the document to create a first output file, the first output file being adapted to be processed by a first publisher's formatting engine to create the document.

18. The master format specification of claim 17, wherein the master format specification includes an XML data file.

19. The master format specification of claim 17, wherein the first requirements file is adapted to process another composition file including content from another document to create a second output file, the second output file being adapted to be processed by the first publisher's formatting engine to create the other document.

20. The master format specification of claim 17, wherein the master format specification is adapted to generate a second requirements file unique to the user, the second requirements file being based on a second publisher's requirements.

21. The master format specification of claim 20, wherein the second requirements file is adapted to process the composition file including content from the document to create a second output file, the second output file being adapted to be processed by a second publisher's formatting engine to create the document.

22. A system for publishing documents, comprising:
a first arrangement for extracting a design specification from the document, the design specification including at least one of page size, page margins, paragraph style, and font style;
a second arrangement for creating a master format specification from the design specification, the master format specification including an XML data file and being content neutral;
a third arrangement for extracting a content from the document and creating a composition file from the content; and
a fourth arrangement for transforming the XML data file into a first publisher's requirements to create a first requirements file unique to the user.

23. The system for publishing documents of claim 22, further comprising an arrangement for processing the composition file by the first requirements file to create an output file adapted to be accepted by a proprietary formatting engine of a first publisher.
